(19) United States
(12) Patent Application Publication
(10) Pub. No.: US 2014/0303114 A1
(43) Pub. Date: Oct. 9, 2014

(54) METHOD FOR THE EXTRACTION OF FURAN DERIVATIVE COMPOUNDS FROM SEEDS OF HASS AVOCADO (Persea americana Mill) AT LOW TEMPERATURE AND THEIR USE AS REPELLENTS AND MITICIDES AGAINST Tetranychus urticae, Tetranychus cinnabarinus, Oligonychus yothersi, Panonychus citri, and Brevipalpus chilensis.

(71) Applicant: Instituto de Investigaciones Agropecuarias (INIA), Santiago (CL)

(72) Inventor: Robinson Vargas Mesina, Santiago (CL)

(21) Appl. No.: 14/310,297

(22) Filed: Jun. 20, 2014

Related U.S. Application Data
(63) Continuation-in-part of application No. 13/232,449, filed on Sep. 14, 2011.

(30) Foreign Application Priority Data
Sep. 16, 2010 (CL) 201000987

(51) Int. Cl. A01N 43/16; A01N 37/02; A01N 43/08

(52) U.S. Cl. CPC A01N 43/16; A01N 43/08; A01N 37/02
USPC 514/53

(57) ABSTRACT

This invention relates to the extraction and use of bioactive compounds from avocado seeds (var. Hass; Persea americana Mill) at room temperature. The extraction was performed with dichloromethane as a solvent using a simple diffusion mechanism within pressed avocado seeds. The extracted compounds were identified as furan derivative structures and fragments derived thereof that exhibited repellent and miticide activity against mite species of economic interest: Tetranychus urticae, Tetranychus cinnabarinus, Oligonychus yothersi, Panonychus citri, and Brevipalpus chilensis. The compounds obtained have the general structure of a disubstituted furan, as illustrated in FIG. 1, and the fragments thereof are derived from mono-substituted furans and from side-chain fragments. The utility of these compounds as repellents was determined over a 48-hour period, and their function as miticides was evaluated for 24 hours after application.

### CROSS-REFERENCE TO RELATED PATENT APPLICATIONS

This application is a continuation-in-part of U.S. patent application Ser. No. 13/232,449 filed on Sep. 14, 2011, which claims its priority to a Chilean Patent Application 201000987 filed Sep. 16, 2010, the disclosures of both applications are herein incorporated in their entireties.

### BACKGROUND OF THE INVENTION

Many pesticides cause severe unfavorable effects including a high toxicity in humans and animals, a relatively high phytotoxicity in plants, and an increasing resistance level in insects and mites. Despite the wide spectrum of pesticides currently available, pests continue to remain a serious problem and environmentally friendly biocides have yet to be developed.

This invention refers to biopesticides with a quantitative improvement in bioactive components through the use of the extraction method described in detail bellow. In particular, the method of extraction of the biocides, the temperature and type of solvent used were controlled to obtain a different composition with more stable structures.

Environmentally friendly biocidal products, focused on the problem described above, have been previously approached by the inventor of the present application (R. Vargas, Chilean Patent Application No. 00987-2010, US Patent Application No. 20120071551) and by several other inventors.

However, there remains a need for new compositions of biocides that can be safe and widely applied. The present application describes a quantitative improvement in bioactive components through the use of the extraction method proposed in the present invention. In particular, the temperature and type of solvent used for this extraction were controlled to obtain a different composition with more stable structures.

It is generally known that components from both the leaves and the pulp from avocado seeds have certain toxic effects on animals and on specific stages of insect development (Univ. California Cooperative Extension, San Diego County Farm Advisor Agricultural News (1997)). However, there are two different approaches of study that one can take to ascertain a clear, systematic and reproducible method of identifying the specific components responsible for these toxic effects. The first approach refers to the use of avocadofuran compounds obtained from avocados to hinder the larval stage development of specific insects. Using this approach, unsaturated compounds such as persin (1-acetoxy-2-hydroxy-4-oxo-heneicosa-(12Z, 15Z)-diene) are known to inhibit the growth in the fourth larval stage of the Bombyx mori L. silkworm (Agr. Biol. Chem., 39: 1167 (1975) and of Spodoptera exigua (Entomol. Experiment. Applic. 90(2), 131-140, 1999).

Regarding the same growth inhibition effects on insect larval development, U.S. Pat. No. 6,133,313 by Thomson and collaborators (2000) stated that oily fractions of idioblast cells from the pulp (and not from the avocado seed, as in the present invention) of Persea americana Mill. avocados (Lauraceae) contain avocadofurans which are responsible for the inhibitory effects on insect larvae.

The second study approach concerns the use of compounds extracted with ethanol, under reflux, from avocado seeds by the author of the present invention (R. Vargas, Chilean Patent Application No. 00987-2010 and US Patent Application No. 20120071551). Of these compounds, mono-substituted furan derivatives with compositions that differ from those described in the first approach (above) were effective as miticides against Tetranychus urticee and Brevipalpus chilensis and also as insecticides against Hemiberlesia lateniee and Heliothrips haemonrrhoidalis. Moreover, the US Patent Application No 20110217251 (Meretzki et al) also described the extraction of avocado seeds with hexane by freezing the seeds, followed by freeze drying and solvent extraction with hexane for 14 hours under reflux. The aim was to obtain polyhydroxylated fatty alcohols with applications in human therapy without separating any furan derivatives, such as the derivatives obtained in the present application.

The following studies reveal the current status of knowledge regarding the mites Panonychus citri, Oligonychus yothersi, and Tetranychus cinnabarinus.

a) Panonychus citri:

In U.S. Pat. No. 4,640,836 (Boulter, A. et al.), inhibitors of trypsin and chymotrypsin extracted from avocado seeds were used. Solutions of these enzyme inhibitors were sprayed on cotton plants infected with different pests, among which the red mite Panonychus citri was present. In general, extracts of Vigna unguiculata (commonly called cowpea) are preferred.

The results showed that contact with these enzyme biocides had a lethality rate of 100% after 5 days for both larvae and adults.

b) Oligonychus yothersi:

Although basic research studies have been performed on the control of Oligonychus yothersi, there are still no efficient organic or biological alternatives for the control of this mite species in particular.

c) Tetranychus cinnabarinus:

As in the case of Oligonychus yothersi, basic research studies have been performed to examine the control of Tetranychus cinnabarinus; however, there is still no efficient organic or biological alternative for specific control of this mite species.

In summary, the following has been established:
Unsaturated derivatives such as persin (1-acetoxy-2-hydroxy-4-oxo-eicosan-(12Z,15Z)-diene) obtained from the leaves and seeds of fruits can act as inhibitors of the growth of worms at various larval stages.
The oily fraction of idioblastic cells from avocado pulp acts as an inhibitor of insects at various larval stages.
Ethanolic extracts obtained from avocado seeds under reflux act as biocides and are lethal to Tetranychus urticae and Brevipalpus chilensis (as determined by the inventor submitting this patent application, 2010).
Hexane extracts obtained by freezing the avocado seeds followed by lyophilization and subsequent reflux contain polyhydroxy fatty alcohols, which have applications in human therapy; however, the furan derivatives described in the current patent application are not obtained using this method.

None of these previous reports has demonstrated the use of di-alkyl furans obtained from avocado seeds at room temperature as repellents and miticides against Tetranychus urticae, Tetranychus cinnabarinus, Oligonychus yothersi, Panonychus Oil, and Brevipalpus chilensis. These di-alkyl furans are fast-acting and more highly efficient than other previously described compounds.

Although it is known that di-alkyl furan structures do exist in nature, particularly in soybean oil (Guth, H., and W. Grosch, Detection of Fatty Acids in Furanoid Soya bean Oil-Cause for the Light induced Off-Flavour, Fat Sci Technol, 93:249-255 (1991)), these structures have not been reported in extracts of avocado seeds, as in the present invention.

### BRIEF SUMMARY OF THE INVENTION

One embodiment provides a method for obtaining an extract comprising bioactive compounds against mites. In this method, avocado seeds are pressed at room temperature to a thickness of 0.16-0.47 inches, based on the original size of the seeds. The pressed seeds are then treated with 96% ethanol at the temperature of 10-15° C. for 2-4 hours; and ethanol is then removed and the bioactive compounds are extracted from the seeds by using simple diffusion for a period of 6 to 8 hours with dichloromethane at the room temperature. The extract is then analyzed by high-performance liquid chromatography and mass spectrometry and confirming the presence in the extract of the bioactive compounds against mites. In some embodiments, extraction with dichloromethane yields mainly di-alkylfuran compounds while extraction with ethanol at reflux temperature yields only mono-alkyl substituted furans with furanyl and alkyl functionalized fragments. In further embodiments, the amount of furan derivatives extracted with refluxing ethanol is 8%, while the extraction with dichloromethane at the room temperature yields an amount that is 2.0-2.5 times higher, which provides a higher extract bioactivity. In other embodiments, after separating the dichloromethane-soluble components, a white solid residue remains which exhibits repellency, but not lethality and which enables stable compaction of di-alkyl furans within the seeds.

Further embodiments provide an extract composition obtained by simple diffusion with dichloromethane as described above. The extract composition comprising a combination of the following compounds: 2-furanaldehyde (4.67%), 2-(penten-3-yl) furan (1.47%); 2-(hexen-3-yl) furan (1.17%); 7-(furan-2-yl)-2,4-dioxohepten-5-yl acetate (0.69%); 2,4-dioxotetradecanyl acetate (4.46%); 2-(tetradeca-3,6-dien-13-inyl) furan (1.40%); 2-hydroxy-4-oxo-tetradecanyl acetate (4.25%); 2,4-dihydroxybutyl acetate (0.22%); 7-(furan-2-yl)-2,4-dihydroxyhepten-5-yl acetate (1.68%); 2-[12-sacarosyl-2-en-8,10-dihydroxy decanoate]-5-[2,6,10-trienyl-18-nonadecynyl]-furan (80.00%), which repels mites and acts as a miticide.

Other embodiments provide a method for repelling at least one of the following adult mite species: Tetranychus urticae, Tetranychus cinnabarinus, Oligonychus yothersi, Panonychus citri and Brevipalpus chilensis. This method comprises applying to a surface the extract obtained by the methods described above in the form of a 20% (v/v) ethanol/water solution at the concentration of 5000 ppm. Further embodiments include a method in which the bioactivity of the composition obtained by the methods described above as a repellent against the aforementioned mite species in the adult stages is verified through measurements obtained during 48 hours of observation of mites' behavior on the surface treated with said composition. At least in some embodiments, the method for repelling mite species results in the percentages of adult mites repelled by the composition after 48 hours of observation is as follows: 80% for Tetranychus urticae, 70% for Tetranychus cinnabarinus, 70% for Oligonychus yothersi, 75% for Panonychus citri, and 73% for Brevipalpus chilensis.

### BRIEF DESCRIPTION OF THE DRAWINGS

FIG. 1 is the general structure of di-alkyl furans in the dichloromethane extract of avocado seeds, Persea americana var. Hass, at room temperature.

### DETAILED DESCRIPTION OF THE INVENTION

Extraction of repellent and miticide compounds from avocado seeds: Avocado seeds (var. Hass) were taken directly from the trees as is normally done with avocados ready to be consumed as a meal within a period of one to five days at room temperature. Then cleaned, washed, and submit to extraction of biocides. The method of extraction is by simple diffusion using ethanol, and dichloromethane as the solvent, at room temperature. The avocado seeds (var. Hass) were then pressed with a commercial press exerting a pressure of 4 tons at room temperature to a predetermined point. Specifically, the seeds were vertically pressed to a thickness of 0.16-0.47 in, depending on their original size. The pressed seeds were treated with ethanol (96%) for 2 hours at a temperature between 10 and 15° C. to separate the hydrophilic components present in the seeds; the solvent was then separated at room temperature. Subsequently, 2 kg of seeds treated as described were placed in a stainless steel container, and 1.5 L of dichloromethane (99%) was added. The lid of the container was sealed, and the seeds were extracted for a period of 8 to 10 hours. The extracted compounds were filtered, and the solvent was then evaporated from the filtrate using a rotary evaporator (Buchi R-215) at a temperature below 35° C. to obtain a viscous extract (20% yield), which was reddish-brown in color.

Determination of the extract composition: Separation of the compounds in the extract was performed by high-resolution liquid chromatography (HPLC, Agilent 1200s, MS/MS QqQ, 6410) using a reverse-phase column (Agilent Xorbax C18, 150×4.6 mm, 5 pm) with 0.1% (v/v) formic acid (A) and 0.1% (v/v) acetonitrile (B) as solvents. The separation gradient was as follows: 0-5 min, 10-25% A; 5-8 min, 25-35% A; 8-15 min, 35-60% B; 15-17 min, 60-35% A; and finally 17-20 min, 35-10% A. The flow rate was 1 mL/min at room temperature.

Subsequently, mass spectrometry was performed to identify the previously separated compounds, which corresponded to sweep analysis (“untarget” scan mode) and MRM; the mass range was 50-1000 m/z. The parameters of the MS/MS are presented in Table 1.

TABLE 1
Parameters used for HPLC chromatography-mass spectrometry

| HPLC-MS PARAMETERS | VALUE | |
|---|---|---|
| N₂ temperature | 330° | C. |
| N₂ flow | 8 | L/min |
| Spraying pressure | 45 | psi. |
| Capillary voltage | 4000 | V |
| Operation mode | Sweep | |
| Mass range | 50-1000 | m/z |

Under these conditions, the following compounds were identified in the dichloromethane extract.

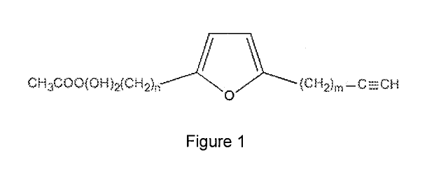

FIG. 1 shows the general structure of di-alkyl furans in the dichloromethane extract of avocado seeds, Persea americana var. Hass, at room temperature. Compounds with this general structure, and derivatives thereof, are bioactive against the following species of mites: Tetranychus urticae, Tetranychus cinnabarinus, Oligonychus yothersi, Panonychus citri, and Brevipalpus chilensis.

The composition of the dichloromethane extract is given in Table 2.

TABLE 2
Composition of the dichloromethane extract from avocado seeds

| COMPOUND | AMOUNT (%) |
|---|---|
| 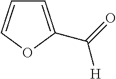 2-Furanaldehyde | 4.67 |
| 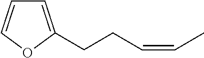 2-(Penten-3-yl)furan | 1.47 |
| 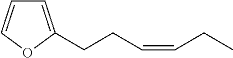 2-(Hexen-3-yl)furan | 1.17 |
| 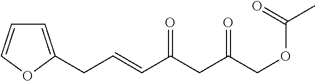 [SMILES: CC(=O)OCC(=O)CC(=O)/C=C/Cc1ccco1] 7-(furan-2-yl)-2,4-dioxohepten-5-yl acetate | 0.69 |
| 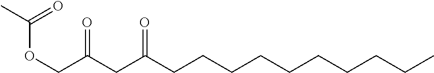 [SMILES: CCCCCCCCCCC(=O)CC(=O)COC(C)=O] 2,4-dioxotetradecanyl acetate | 4.46 |
| 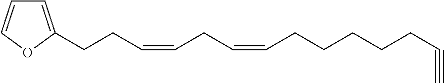 [SMILES: C#CCCCCC/C=C\C/C=C\CCc1ccco1] 2-(tetradeca-3,6-dien-13-inyl)furan | 1.40 |
| 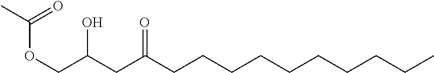 [SMILES: CCCCCCCCCCC(=O)CC(O)COC(C)=O] 2-hydroxy-4-oxo-tetradecanyl acetate | 4.25 |
| 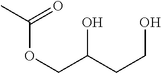 2,4-dihydroxybutyl acetate | 0.22 |
| 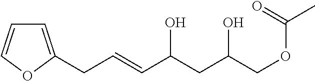 [SMILES: CC(=O)OCC(O)CC(O)/C=C/Cc1ccco1] 7-(furan-2-yl)-2,4-dihydroxy-hepten-5-yl acetate | 1.68 |
| 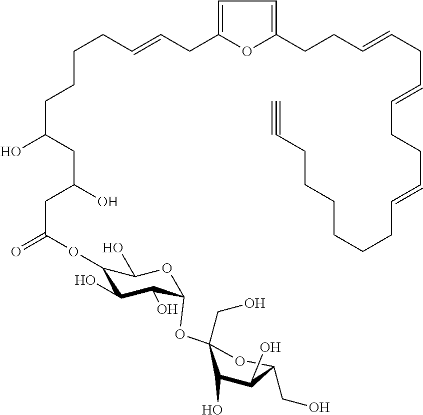 2-[12-sacarosyl-2-en-8,10-dihydroxy decanoate]-5-[2,6,10- trienyl-18-nonadecynyl]furan | 80.00 |

### Bioassays of the Repellent Activity of the Dichloromethane Extracts

a) Tetranychus urticae (McGregor).

The repellent effect of the avocado seed extracts was evaluated at a concentration of 5000 ppm in 20% (v/v) ethanol/water using mature Tetranychus urticae (McGregor). These direct application bioassays were conducted in Petri dishes 5 cm in diameter. A total of 509′ of the Petri dish surface was covered with 2 mL of avocado seed extract at a concentration of 5000 ppm in 20% ethanol (v/v). The extract was applied by spraying with a Potter tower (Burkard Manufacturing Co. Ltd.). Then, the Petri dish was dried at room temperature in a dark environment, and mature mites were deposited. An experimental unit included 10 mature mites in a Petri dish, and 4 replicates were carried out for each treatment. Adult repellency was evaluated as a function of time by counting the number of mites remaining in the area of the plate to which no extract was applied during 48 hours of observation,

b) Tetranychus cinnabarinus (Boisduval)

The repellent effect of the avocado seed extracts was evaluated at a concentration of 5000 ppm in 20% (v/v) ethanol/water using mature Tetranychus cinnabarinus (Boisduval). These direct application bioassays were conducted in Petri dishes 5 cm in diameter. A total of 50% of the Petri dish surface was covered with 2 mL of avocado seed extract at a concentration of 5000 ppm in 20% ethanol (v/v). The extract was applied by spraying with a Potter tower (Burkard Manufacturing Co. Ltd.). Then, the Petri dish was dried at room temperature in a dark environment, and mature mites were deposited. An experimental unit included 10 mature mites in a Petri dish, and 4 replicates were carried out for each treatment. Adult repellency was evaluated as a function of time by counting the number of mites remaining in the area of the plate to which no extract was applied during 48 hours of observation.

c) Oligonychus yothersi (McGregor)

The repellent effect of the of avocado seed extracts was evaluated at a concentration of 5000 ppm in 20% (v/v) ethanol/water using mature Oligonychus yothersi (McGregor). These direct application bioassays were conducted in Petri dishes 5 cm in diameter. A total of 50% of the Petri dish surface was covered with 2 mL of avocado seed extract at a concentration of 5000 ppm in 20% ethanol (v/v). The extract was applied by spraying with a Potter tower (Burkard Manufacturing Co. Ltd.). Then, the Petri dish was dried at room temperature in a dark environment, and mature mites were deposited. An experimental unit included 10 mature mites in a Petri dish, and 4 replicates were carried out for each treatment. Adult repellency was evaluated as a function of time by counting the number of mites remaining in the area of the plate to which no extract was applied during 48 hours of observation.

d) Panonychus citri (McGregor)

The repellent effect of the of avocado seed extracts was evaluated at a concentration of 5000 ppm in 20% (v/v) ethanol/water using mature Panonychus citri (McGregor). These direct application bioassays were conducted in Petri dishes 5 cm in diameter. A total of 50% of the surface of the Petri dish was covered with 2 mL of avocado seed extract at a concentration of 5000 ppm in 20% ethanol/water (v/v). The extract was applied by spraying with a Potter tower (Burkard Manufacturing Co. Ltd.). Then, the Petri dish was dried at room temperature in a dark environment, and mature mites were deposited. An experimental unit included 10 mature mites in a Petri dish, and 4 replicates were carried out for each treatment. Adult repellency was evaluated as a function of time by counting the number of mites remaining in the area of the plate to which no extract was applied during 48 hours of observation.

e) Brevipalpus chilensis (Baker)

The repellent effect of the of avocado seed extracts was evaluated at a concentration of 5000 ppm in 20% (v/v) ethanol/water using mature Brevipalpus chilensis (McGregor). These direct application bioassays were conducted in Petri dishes 5 cm in diameter. A total of 50% of the surface of the Petri dish was covered with 2 mL of avocado seed extract at a concentration of 5000 ppm in 20% ethanol/water (v/v). The extract was applied by spraying with a Potter tower (Burkard Manufacturing Co. Ltd.). Then, the Petri dish was dried at room temperature in a dark environment, and mature mites were deposited. An experimental unit included 10 mature mites in a Petri dish, and 4 replicates were carried out for each treatment. Adult repellency was evaluated as a function of time by counting the number of mites remaining in the area of the plate to which no extract was applied during 48 hours of observation.

### Repellency Results

The results of the repellency bioassays are presented in Tables 3 through 7 below:

a) Tetranychus urticae repellency

TABLE 3
Ability of avocado seed extracts to repel adult Tetranychus
urticae during 48 hours of observation in the laboratory.

| | Repellency |
|---|---|
| Treatments | (% of observation time) |
| Area with no application | 80 a |
| Avocado seed extract (5000 ppm in | 20 b |
| 20% (v/v) ethanol/water) (application zone) | |

a and b indicate significant differences between treatments according to Student's t test (LSD, ρ ≦ 0.05).

b) Tetranychus cinnabarinus repellency

TABLE 4
Ability of avocado seed extracts to repel adult Tetranychus
cinnabarinus during 48 hours of observation in the laboratory.

| | Repellency |
|---|---|
| Treatments | (% of observation time) |
| Area with no application | 70 a |
| Avocado seed extract (5000 ppm in | 30 b |
| 20% (v/v) ethanol/water) (application zone) | |

a and b indicate significant differences between treatments according to Student's t test (LSD, ρ ≦ 0.05).

c) Oligonychus yothersi repellency

TABLE 5
Ability of avocado seed extracts to repel adult Oligonychus
yothersi during 48 hours of observation in the laboratory.

| | Repellency |
|---|---|
| Treatments | (% of observation time) |
| Area with no application | 70 a |
| Avocado seed extract (5000 ppm in | 30 b |
| 20% (v/v) ethanol/water) (application zone) | |

a and b indicate significant differences between the treatments according to Student's t test (LSD, ρ ≦ 0.05).

d) Panonychus citri repellency

TABLE 6
Ability of avocado seed extracts to repel adult Panonychus
citri during 48 hours of observation in the laboratory.

| | Repellency |
|---|---|
| Treatments | (% of observation time) |
| Area with no application | 75 a |
| Avocado seed extract (5000 ppm in | 25 b |
| 20% (v/v) ethanol/water) (application zone) | |

a and b indicate significant differences between treatments according to Student's t test (LSD, ρ ≦ 0.05).

e) Brevipalpus chilensis repellency

TABLE 7
Ability of avocado seed extracts to repel adult Brevipalpus
chilensis during 48 hours of observation in the laboratory.

| | Repellency |
|---|---|
| Treatments | (% of observation time) |
| Area with no application | 73 a |
| Avocado seed extract (5000 ppm in | 27 b |
| 20% (v/v) ethanol/water) (application zone) | |

a and b indicate significant differences between treatments according to Student's t test (LSD, ρ ≦ 0.05).

Bioassays of the bioactivity of water-soluble dichloromethane extracts of solid seeds: After removing the other components, the remaining dichloromethane residue was observed as a white solid that was soluble in water. Bioactivity assays were performed with this aqueous component using the bioassay methodology outlined above. The bioassays revealed that direct lethality was not achieved; rather, sublethal repellency was observed. This repellency was equivalent to that observed in the bioassays described above, which lacked the solid component, during 24 hours of observation. Based on the results of these bioassays, 76% repellency against Tetranychus urticae was achieved. This result indicates that the di-alkyl furan extracted from avocado seeds with dichloromethane at room temperature and present as a white solid has the potential to be repellent.

### Bioassays of the Miticide Activity of the Dichloromethane Extracts

a) Tetranychus urticae (McGregor).

The lethal effect of the avocado seed extracts was evaluated at a concentration of 5000 ppm in 20% (v/v) ethanol/water using mature Tetranychus urticae (McGregor). These direct application bioassays were conducted using leaf discs of bean (Phaseolus vulgaris cv. Apollo) and mature mites deposited on moistened cotton. A 2 mL aliquot of the avocado seed extract at a concentration of 5000 ppm in 20% ethanol/water (v/v) was applied by spraying with a Potter tower (Burkard Manufacturing Co. Ltd.). An experimental unit included 10 mature mites on a leaf disk, and 5 replicates were carried out for each treatment in addition to a control treatment with 20% ethanol (v/v) in water. The adult lethality was assessed 24 hours after application.

b) Tetranychus cinnabarinus (Boisduval)

The lethal effect of the avocado seed extracts was evaluated at a concentration of 5000 ppm in 20% (v/v) in ethanol/water using mature Tetranychus cinnabarinus (Boisduval). These direct application bioassays were conducted using leaf discs of bean (Phaseolus vulgaris cv. Apollo) and mature mites deposited on moistened cotton. A 2 mL aliquot of the avocado seed extract at a concentration of 5000 ppm in 20% ethanol (v/v) was applied by spraying with a Potter tower (Burkard Manufacturing Co. Ltd.). One experimental unit included 10 mature mites on a leaf disk, and 5 replicates were carried out for each treatment in addition to a control treatment with 20% ethanol (v/v) in water. The adult lethality rate was assessed 24 h after application.

c) Oligonychus yothersi (McGregor)

The lethal effect of the avocado seed extracts was evaluated at a concentration of 5000 ppm in 20% (v/v) ethanol/water using mature Oligonychus yothersi (McGregor). These direct application bioassays were conducted by placing leaf discs of Hass avocado (Persea americana) on moistened cotton and depositing mature mites. A 2 mL aliquot of avocado seed extract at a concentration of 5000 ppm in 20% ethanol/water (v/v) was applied by spraying with a Potter tower (Burkard Manufacturing Co. Ltd.). Each experimental unit included 10 mature mites on a leaf disk, and 5 replicates were carried out for each treatment in addition to a control treatment with 20% ethanol (v/v) in water. The adult lethality rate was assessed 24 h after application.

d) Panonychus citri (McGregor)

The lethal effect of the avocado seed extracts was evaluated at a concentration of 5000 ppm in 20% (v/v) ethanol/water using mature Panonychus citri (McGregor). These direct application bioassays were conducted by placing leaf discs of orange (Citrus sinensis) on moistened cotton and depositing mature mites. A 2 mL aliquot of avocado seed extract at a concentration of 5000 ppm in 20% ethanol/water (v/v) was applied by spraying with a Potter tower (Burkard Manufacturing Co. Ltd.). One experimental unit included 10 mature mites on a leaf disk; 5 replicates for each treatment were carried out in addition to a control treatment with 20% ethanol (v/v) in water. The adult lethality rate was assessed 24 h after application.

e) Brevipalpus chilensis (Baker)

The lethal effect of the avocado seed extracts was evaluated at a concentration of 5000 ppm in 20% (v/v) ethanol/water using mature Brevipalpus chilensis (Baker). These direct application bioassays were conducted by placing privet (Ligustrum sp) leaf discs on moist cotton and depositing mature mites. A 2 mL aliquot of avocado seed extract at a concentration of 5000 ppm in 20% ethanol/water (v/v) was applied by spraying with a Potter tower (Burkard Manufacturing Co. Ltd.). One experimental unit contained 10 mature mites on a leaf disk; 5 replicates for each treatment were carried out in addition to a control treatment with 20% ethanol (v/v) in water. The adult lethality rate was assessed 24 h after application.

### Lethality Results

Lethality results are shown in Tables 8 through 12.

a) Lethality against Tetranychus urticae

TABLE 8
Effect of direct application of avocado seed extracts on adult Tetranychus
urticae after 24 hours of application in the laboratory.

| Treatment | Lethality (%) |
|---|---|
| Extract (5000 ppm | 78 a |
| in 20% (v/v) ethanol/water) | |
| Control with 20% (v/v) ethanol/water | 6 b |

a and b indicate significant differences between treatments according to Student's t test (LSD, ρ ≦ 0.05).

b) Lethality against Tetranychus cinnabarinus

TABLE 9
Effect of direct application of avocado seed extracts on adult Tetranychus
cinnabarinus after 24 hours of application in the laboratory.

| Treatments | Lethality (%) |
|---|---|
| Extract Fraction 1 (5000 ppm in | 82 a |
| 20% (v/v) ethanol/water) | |
| Control with 20% (v/v) ethanol/water | 6 b |

a and b indicate significant differences between treatments according to Student's t test (LSD, ρ ≦ 0.05).

c) Lethality against Oligonychus yothersi

TABLE 10
Effect of direct application of avocado seed extracts on adult Oligonychus
yothersi after 24 hours of application in laboratory.

| Treatments | Lethality (%) |
|---|---|
| Extract Fraction 1 (5000 ppm in | 98 a |
| 20% (v/v) ethanol/water) | |
| Control with 20% (v/v) ethanol/water | 6 b |

a and b indicate significant differences between treatments according to Student's t test (LSD, ρ ≦ 0.05).

d) Lethality against Panonychus citri

TABLE 11
Effect of direct application of avocado seed extract on adult Panonychus
citri after 24 hours of application in the laboratory

| Treatments | Lethality (%) |
|---|---|
| Extract (5000 ppm in | 98 a |
| 20% (v/v) ethanol/water) | |
| Control with 20% (v/v) ethanol/water | 10 b |

a and b indicate significant differences between treatments according to Student's t test (LSD, ρ ≦ 0.05).

e) Lethality against Brevipaipus chilensis

TABLE 12
Effect of direct application of avocado seed extract on adult Brevipalpus
chilensis after 24 hours of application in the laboratory.

| Treatments | Lethality (%) |
|---|---|
| Extract 1 (5000 ppm in | 94 a |
| 20% (v/v) ethanol/water) | |
| Control with 20% (v/v) ethanol/water | 0 b |

a and b indicate significant differences between treatments according to Student's t test (LSD, ρ ≦ 0.05).

While certain embodiments and best mode are described herein, it will be apparent to those skilled in the art that modifications may be made therein without departing from the spirit of the invention and the scope of the appended claims.

What is claimed is:

1. A method for obtaining an extract comprising bioactive compounds against mites, the method comprising:
a) obtaining avocado seeds;
b) breaking the seeds by pressing them at the room temperature to a thickness of 0.16-0.47 inches, based on the original size of the seeds;
c) treating the pressed seeds of step b) with 96% ethanol at the temperature of 10-15 ° C. for 2-4 hours;
d) removing the ethanol and subsequently extracting the compounds from the seeds by using simple diffusion for a period of 6 to 8 hours with dichloromethane at the room temperature; and
e) analyzing the extract by high-performance liquid chromatography and mass spectrometry and confirming the presence in the extract of the bioactive compounds against mites.

2. An extract composition obtained by the method of claim 1, wherein the extract composition comprises a combination of the following compounds: 2-furanaldehyde (4.67%); 2-(penten-3-yl) furan (1.47%); 2-(hexen-3-yl) furan (1.17%); 7-(furan-2-yl)-2,4-dioxohepten-5-yl acetate (0.69%); 2,4-dioxotetradecanyl acetate (4.46%); 2-(tetradeca-3,6-dien-13-inyl) furan (1.40%); 2-hydroxy-4-oxo-tetradecanyl acetate (4.25%); 2,4-dihydroxybutyl acetate (0.22%); 7-(furan-2-yl)-2,4-dihydroxyhepten-5-yl acetate (1.68%); 2-[12-sacarosyl-2-en-8,10-dihydroxy decanoate]-5-E[2,6,10-trienyl-18-nonadecynyl]-furan (80.00%), which repels mites and acts as a miticide.

3. The method of claim 1, wherein extraction with dichloromethane yields mainly di-alkylfuran compounds while extraction with ethanol at reflux temperature yields only mono-alkyl substituted furans with furanyl and alkyl functionalized fragments.

4. The method of claim 1, wherein the amount of furan derivatives extracted with refluxing ethanol is 8%, while the extraction with dichloromethane at the room temperature yields an amount that is 2.0-2.5 times higher, which provides a higher extract bioactivity.

5. The method of claim 1, wherein after separating the dichloromethane-soluble components, a white solid residue remains which exhibits repellency, but not lethality and which enables stable compaction of di-alkyl furans within the seeds.

6. A method for repelling at least one of the following adult mite species: Tetranychus urticae, Tetranychus cinnabarinus, Oligonychus yothersi, Panonychus citri and Brevipalpus chilensis, wherein the method comprises applying to a surface the extract obtained by the method of claim1 in the form of a 20% (v/v) ethanol/water solution at the concentration of 5000 ppm.

7. The method of claim 6, wherein the bioactivity of the composition as a repellent against the aforementioned mite species in the adult stages is verified through measurements obtained during 48 hours of observation of mites' behavior on the surface treated with said composition.

8. The method of claim 6, wherein the percentages of adult mites repelled by the composition after 48 hours of observation is as follows: 80% for Tetranychus urticae, 70% for Tetranychus cinnabarinus, 70% for Oligonychus yothersi, 75% for Panonychus citri, and 73% for Brevipalpus chilensis.

9. The method of claim 6, wherein the bioactivity of the composition as a miticide against the adult species is verified by measuring the number of dead individuals 24 hours after the composition is applied to the mites.

10. The method of claim 8, wherein the percentages of dead individuals observed 24 hours after the application of the composition are as follows: Tetranychus urticae, 78%; Tetranychus cinnabarinus, 82%; Oligonychus yothersi, 98%; Panonychus citri, 98%; and Brevipalpus chilensis, 94%.

11. The method of claim 9, wherein application of the composition at different concentrations led to different rates of lethality according to the type of plant or fruit on which the mites are found.

12. The method of claim 11, wherein the miticide bioactivities of different concentrations of the composition against adult Tetranychus urticae after 48 hours of observation are as follows: 100% with 5000 ppm, 76% with 4000 ppm, 82% with 3000 ppm, and 38% with 2000 ppm.

13. The method of claim 1, wherein step a) is performed with a commercial press that exerts a pressure of 4 tons with horizontal plates.
